(19) United States
(12) Patent Application Publication
(10) Pub. No.: US 2023/0207872 A1
(43) Pub. Date: Jun. 29, 2023

(54) NONAQUEOUS ELECTROLYTE SECONDARY BATTTERY POROUS LAYER

(71) Applicant: Sumitomo Chemical Company, Limited, Tokyo (JP)

(72) Inventors: Kensaku HORIE, Niihama-shi (JP); Makoto FURUKAWA, Niihama-shi (JP); Shun NAKAZAWA, Niihama-shi (JP)

(21) Appl. No.: 18/075,836

(22) Filed: Dec. 6, 2022

(30) Foreign Application Priority Data
Dec. 7, 2021 (JP) 2021-198753

(51) Int. Cl. H01M 10/0565; H01M 50/417; H01M 50/491; H01M 10/0525

(52) U.S. Cl. CPC H01M 10/0565; H01M 50/417; H01M 50/491; H01M 10/0525

(57) ABSTRACT

As a nonaqueous electrolyte secondary battery porous layer that is excellent in durability with respect to charge-discharge cycles, provided is a nonaqueous electrolyte secondary battery porous layer including a resin which has an amide bond and which contains a component that is to be eluted into N-methylpyrrolidone. A contained amount of the component that is to be eluted into N-methylpyrrolidone is not less than 6.0% by weight and not more than 25.0% by weight relative to a total weight of the resin having the amide bond.

### TECHNICAL FIELD

The present invention relates to a porous layer for a nonaqueous electrolyte secondary battery (hereinafter, referred to as a “nonaqueous electrolyte secondary battery porous layer”).

### BACKGROUND ART

Nonaqueous electrolyte secondary batteries, particularly lithium-ion secondary batteries, have high energy densities, and are thus in wide use as batteries for personal computers, mobile telephones, portable information terminals, and the like. Recently, such nonaqueous electrolyte secondary batteries have been developed as batteries for vehicles.

The end-of-charge voltages of conventional nonaqueous electrolyte secondary batteries are approximately 4.1 V to 4.2 V (4.2 V to 4.3 V (vs Li/Li⁺) as voltages relative to the electric potentials of lithium reference electrodes). In contrast, the end-of-charge voltages of recent nonaqueous electrolyte secondary batteries are increased to not less than 4.3 V, which is higher than those of the conventional nonaqueous electrolyte secondary batteries, so that the utilization rates of positive electrodes are increased and thereby the capacities of batteries are increased. For this purpose, it is important that resins contained in nonaqueous electrolyte secondary battery porous layers do not change in quality even when the resins are placed under high-voltage conditions.

Patent Literature 1 is one of documents which disclose resins having such a property. Patent Literature 1 discloses a wholly aromatic polyamide in which aromatic rings located at the respective terminals of its molecular chain each does not have an amino group and in which one or more aromatic rings each have an electron-withdrawing substituent. According to Patent Literature 1, the wholly aromatic polyamide hardly changes in color even when the wholly aromatic polyamide receives a high voltage.

### CITATION LIST

### Patent Literature

[Patent Literature 1]

Japanese Patent Application Publication Tokukai No. 2003-40999

### SUMMARY OF INVENTION

### Technical Problem

However, a nonaqueous electrolyte secondary battery porous layer which contains a resin as disclosed in Patent Literature 1 has room for improvement in terms of the number of charge-discharge cycles until a short circuit occurs when charge-discharge cycles are carried out under a high voltage, i.e., in terms of durability with respect to charge-discharge cycles.

### Solution to Problem

The inventors of the present invention have found, as a result of diligent study, that it is possible, by controlling the amount of a component dissolved in N-methylpyrrolidone in a resin that has an amide bond and that constitutes a nonaqueous electrolyte secondary battery porous layer, to improve durability with respect to charge-discharge cycles, and conceived of the present invention.

The present invention has aspects described in <1> through <6> below.

<1> A nonaqueous electrolyte secondary battery porous layer containing at least one type of a resin having an amide bond, the resin having the amide bond containing a component that is to be eluted into N-methylpyrrolidone, and a contained amount of the component that is to be eluted into N-methylpyrrolidone being not less than 6.0% by weight and not more than 25.0% by weight relative to a total weight of the resin having the amide bond,

where the contained amount of the component that is to be eluted into N-methylpyrrolidone is measured by carrying out extraction with respect to the nonaqueous electrolyte secondary battery porous layer using N-methylpyrrolidone.

<2> The nonaqueous electrolyte secondary battery porous layer described in <1>, in which: at least one type of the resin having the amide bond is a block copolymer including a block A containing, as a main component, units each represented by Formula (1) below, and a block B containing, as a main component, units each represented by Formula (2) below.

—(NH—Ar¹—NHCO—Ar²—CO)— Formula (1)

—(NH—Ar³—NHCO—Ar⁴—CO)— Formula (2)

where: Ar¹, Ar², Ar³, and Ar⁴ may each vary from unit to unit; Ar¹, Ar², Ar³, and Ar⁴ are each independently a divalent group having one or more aromatic rings; not less than 50% of all Ar¹ each have a structure in which two aromatic rings are connected by a sulfonyl bond; not more than 50% of all Ar³ each have a structure in which two aromatic rings are connected by a sulfonyl bond; and 10% to 70% of all Ar¹ and Ar³ each have a structure in which two aromatic rings are connected by a sulfonyl bond.

<3> The nonaqueous electrolyte secondary battery porous layer described in <1> or <2>, further containing a filler, a contained amount of the filler being not less than 20% by weight and not more than 90% by weight relative to a total weight of the nonaqueous electrolyte secondary battery porous layer.
<4> A nonaqueous electrolyte secondary battery laminated separator including: a polyolefin porous film; and the nonaqueous electrolyte secondary battery porous layer described in any one of <1> through <3>, the nonaqueous electrolyte secondary battery porous layer being formed on one surface or both surfaces of the polyolefin porous film.
<5> A nonaqueous electrolyte secondary battery member, including a positive electrode, the nonaqueous electrolyte secondary battery porous layer described in any one of <1> through <3> or the nonaqueous electrolyte secondary battery laminated separator described in <4>, and a negative electrode which are disposed in this order.
<6> A nonaqueous electrolyte secondary battery including: the nonaqueous electrolyte secondary battery porous layer described in any one of <1> through <3>; or the nonaqueous electrolyte secondary battery laminated separator described in <4>.

### ADVANTAGEOUS EFFECTS OF INVENTION

The nonaqueous electrolyte secondary battery porous layer in accordance with an embodiment of the present invention brings about an effect of achieving excellent durability with respect to charge-discharge cycles.

### Description of Embodiments

The following description will discuss an embodiment of the present invention. The present invention is, however, not limited to the embodiment below. The present invention is not limited to arrangements described below, but may be altered in various ways by a skilled person within the scope of the claims. The present invention also encompasses, in its technical scope, any embodiment derived by appropriately combining technical means disclosed in differing embodiments. Note that a numerical range “A to B” herein means “not less (lower) than A and not more (higher) than B” unless otherwise stated.

### Embodiment 1: Nonaqueous Electrolyte Secondary Battery Porous Layer

A nonaqueous electrolyte secondary battery porous layer in accordance with Embodiment 1 of the present invention (hereinafter simply referred to also as “porous layer”) is a nonaqueous electrolyte secondary battery porous layer containing at least one type of a resin having an amide bond, the resin having the amide bond containing a component that is to be eluted into N-methylpyrrolidone, and a contained amount of the component that is to be eluted into N-methylpyrrolidone being not less than 6.0% by weight and not more than 25.0% by weight relative to a total weight of the resin having the amide bond.

Here, the contained amount of the component that is to be eluted into N-methylpyrrolidone is obtained by carrying out an extraction operation with respect to the nonaqueous electrolyte secondary battery porous layer using N-methylpyrrolidone.

<Resin Having Amide Bond>

The porous layer in accordance with an embodiment of the present invention contains at least one type of a resin having an amide bond. The resin having an amide bond may be one type of resin or a mixture of two or more types of resins.

The resin having an amide bond has a structure in which divalent groups are connected by chemical bonds and at least one of the chemical bonds is an amide bond.

The resin having an amide bond can be prepared by a polymerization method in which the divalent groups are sequentially connected to each other through the chemical bonds. Therefore, the resin having an amide bond obtained by the preparation method can contain a high molecular weight chain polymer which is constituted by a specific number or greater number of the divalent groups and a specific number or greater number of the chemical bonds. Meanwhile, in the preparation method, a low molecular weight chain polymer is produced as a by-product. The low molecular weight chain polymer is produced by interrupting the connection halfway, and has a smaller number of the divalent groups and the chemical bonds than the high molecular weight chain polymer.

In addition, an intermediate product is produced during the preparation of the resin having an amide bond according to the preparation method. The intermediate product has a smaller number of the divalent groups and the chemical bonds than the high molecular weight chain polymer. Here, when both terminals of the same molecule in the intermediate product condense, a cyclic component is produced as another by-product. The cyclic component has a structure in which the divalent groups are connected by the chemical bonds and no terminals are present.

As described above, in an embodiment of the present invention, the cyclic component is produced from the intermediate product which has a smaller number of the divalent groups and the chemical bonds than the high molecular weight chain polymer. Therefore, the cyclic component has a smaller number of the divalent groups and the chemical bonds than the high molecular weight chain polymer. Accordingly, a weight-average molecular weight of the cyclic component is also smaller than a weight-average molecular weight of the high molecular weight chain polymer.

Specifically, in an embodiment of the present invention, a molecular weight of the chain polymer, in terms of intrinsic viscosity, is preferably 0.5 dL/g to 5.0 dL/g, more preferably 1.0 dL/g to 3.5 dL/g, and further preferably 1.4 dL/g to 2.5 dL/g. Moreover, in an embodiment of the present invention, a molecular weight of the polymer constituting the cyclic component, in terms of intrinsic viscosity, is preferably 0.5 dL/g to 3.0 dL/g, and more preferably 0.7 dL/g to 1.5 dL/g.

In addition, in an embodiment of the present invention, the amide bond is a bond formed by a condensation of an amino group (—NH₂) and a carboxylic halide (—C(═O)X) (X is a halogen atom such as F, Cl, Br, and I). Therefore, the resin having an amide bond can contain a chain polymer whose terminal group is an amino group or a carboxylic halide. Note that the carboxylic halide is slowly hydrolyzed by water in a solvent to produce halogenated hydrogen and a carboxy group. Therefore, the resin having an amide bond can contain a chain polymer whose both terminals are carboxy groups. A chain polymer whose both terminals are carboxy groups is known to have low reactivity with an amino group. Therefore, the chain polymer whose both terminals are carboxy groups tends to cause a subsequent reaction to stop and become a low molecular weight chain polymer.

The low molecular weight chain polymer and the cyclic component each have a small weight-average molecular weight, and are therefore highly soluble in an organic solvent such as

N-methylpyrrolidone (hereinafter, also referred to as “NMP”). It is known that a chain polymer whose both terminals are carboxy groups has higher solubility in an organic solvent such as NMP than a chain polymer having at least one terminal group which is an amino group. Therefore, in a case where the porous layer in accordance with an embodiment of the present invention is subjected to an extraction operation with use of NMP, one or more types of components which are selected from the low molecular weight chain polymer, the cyclic component, and the chain polymer whose both terminals are carboxy groups in the porous layer are extracted in an extraction solution. In other words, the “component that is to be eluted into NMP” in an embodiment of the present invention is one or more selected from the group consisting of the cyclic component, the chain polymer whose both terminals are carboxy groups, and the low molecular weight chain polymer.

Before and after the extraction operation, the weight of the porous layer is measured, and a difference thereof can be calculated as a weight of the “component that is to be eluted into NMP” contained in the porous layer. It is also possible to measure the weight of the “component that is to be eluted into NMP” contained in the porous layer by measuring the weight of the “component that is to be eluted into NMP” contained in the extraction solution.

In the resin having an amide bond, the amide bond accounts for preferably 45% to 85% and more preferably 55% to 75% of the chemical bonds, from the viewpoint of heat resistance of the porous layer.

The divalent groups are not particularly limited. In an embodiment of the present invention, the divalent groups preferably include a divalent aromatic group, and more preferably all of the divalent groups are divalent aromatic groups. The divalent groups may be one type of group or may be two or more types of groups.

In this specification, a “divalent aromatic group” indicates a divalent group that contains an unsubstituted aromatic ring or a substituted aromatic ring, and preferably indicates a divalent group which is constituted by an unsubstituted aromatic ring or a substituted aromatic ring. An “aromatic ring” indicates a cyclic compound which satisfies the Hückel's rule. Examples of the aromatic ring include benzene, naphthalene, anthracene, azulene, pyrrole, pyridine, furan, and thiophene. In an embodiment of the present invention, the aromatic ring is composed solely of carbon atoms and hydrogen atoms. In an embodiment of the present invention, the aromatic ring is a benzene ring or a condensed ring derived from two or more benzene rings (such as naphthalene and anthracene).

In an embodiment of the present invention, a substituent in the divalent group is not particularly limited. In an embodiment of the present invention, the substituent in the divalent group is preferably an electron-withdrawing substituent from the viewpoint of obtaining a nonaqueous electrolyte secondary battery porous layer which is less prone to change in quality even under a high-voltage condition and which has high-voltage resistance. The electron-withdrawing substituent is not particularly limited. Examples of the electron-withdrawing substituent include a carboxyl group, an alkoxycarbonyl group, a nitro group, a halogen atom, and the like.

The chemical bonds may be only amide bonds or may include a bond different from the amide bond. The bond different from the amide bond is not particularly limited. Examples of the bond different from the amide bond include sulfonyl bonds, alkenyl bonds (e.g., C1-C5 alkenyl bonds), ether bonds, ester bonds, imide bonds, ketone bonds, sulfide bonds, and the like. The bond different from the amide bond may be one type of bond or may be two or more types of bonds.

In an embodiment of the present invention, it is preferable that the bond different from the amide bond includes a bond which has stronger electron-withdrawing property than the amide bond, from the viewpoint of obtaining a porous layer having high-voltage resistance. From the viewpoint of further improving the high-voltage resistance of the porous layer, a proportion of the bond which has the stronger electron-withdrawing property than the amide bond in the chemical bonds is more preferably 15% to 35% and further preferably 25% to 35%.

Examples of the bond having the stronger electron-withdrawing property than the amide bond include sulfonyl bonds, ester bonds, and the like among the above listed chemical bonds.

Specific examples of the resin having an amide bond include: polyamides; polyamide imides; and a copolymer of polyamide or polyamide imide and a polymer having one or more bonds which are selected from sulfonyl bonds, ether bonds, and ester bonds. The copolymer may be a block copolymer or may be a random copolymer.

The polyamides are preferably aromatic polyamides. Examples of the aromatic polyamides include wholly aromatic polyamides (aramid resins) and semi-aromatic polyamides. The aromatic polyamides are preferably wholly aromatic polyamides. Examples of the aromatic polyamides include para-aramids and meta-aramids.

The polyamide imides are preferably aromatic polyamide imides. Examples of the aromatic polyamide imides include wholly aromatic polyamide imides and semi-aromatic polyamide imides. The aromatic polyamide imides are preferably wholly aromatic polyamide imides.

Examples of the polymer which constitutes the copolymer and which has one or more bonds selected from the sulfonyl bonds, the ether bonds, and the ester bonds include polysulfone, polyether, polyester, and the like.

The resin having an amide bond is preferably a resin including a portion having flexibility. Examples of the portion having flexibility include an aromatic ring having an amide bond at a meta position, a sulfonyl bond, an ether bond, an ester bond, and the like. In a case where the resin having an amide bond includes a portion having flexibility, in the process of preparing the resin having an amide bond, both terminals of the same molecule in the intermediate product are easily brought closer to each other. Therefore, the both terminals in the intermediate product easily condense. As a result, the cyclic component is easily produced, and the “component that is to be eluted into NMP” can be controlled to fall within a suitable range.

The resin including a portion having flexibility is not particularly limited, and examples thereof include a wholly aromatic polyamide-based resin containing, as a main component, units each represented by Formula (3) below, meta-aramid, and the like. Note that the phrase “main component” means that, among all units contained in the wholly aromatic polyamide-based resin, the units each represented by Formula (3) account for not less than 50%, preferably not less than 80%, more preferably not less than 90%, and further preferably not less than 95%.

—(NH—Ar⁵—NHCO—Ar⁶—CO)— Formula (3)

In Formula (3), Ar⁵ and Ar⁶ may each vary from unit to unit. Ar⁵ and Ar⁶ are each independently a divalent group having one or more aromatic rings.

Not less than 50% of all Ar⁵ each have a structure in which two aromatic rings are connected by a sulfonyl bond. The lower limit of the proportion of Ar⁵ having this structure is more preferably not less than 60% and further preferably not less than 80% of all Ar⁵. Examples of —Ar⁵— having such a structure include 4,4′-diphenylsulfonyl, 3,4′-diphenylsulfonyl, and 3,3′-diphenylsulfonyl.

Examples of —Ar⁵— not having the structure in which two aromatic rings are connected by a sulfonyl bond and —Ar⁶— include the following.

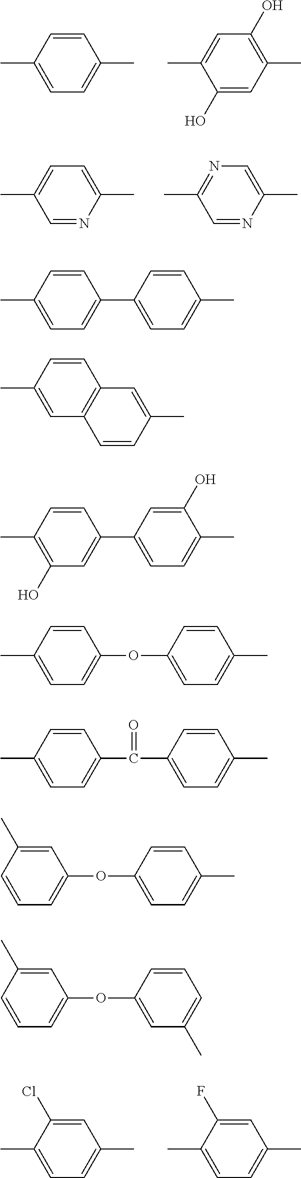

In an embodiment of the present invention, —Ar⁵— having the structure in which two aromatic rings are connected by a sulfonyl bond is 4,4′-diphenylsulfonyl. In an embodiment of the present invention, -Ars- not having the structure in which two aromatic rings are connected by a sulfonyl bond and —Ar6— are paraphenyl.

In an embodiment of the present invention, the wholly aromatic polyamide-based resin containing, as a main component, units each represented by Formula (3) is, for example, an aromatic polyamide having (i) diamine units each derived from 4,4′-diaminodiphenylsulfone and paraphenylenediamine and (ii) dicarboxylic acid units each derived from terephthalic acid (or halogenated terephthalic acid). In another embodiment of the present invention, the wholly aromatic polyamide-based resin containing, as a main component, units each represented by Formula (3) is an aromatic polyamide having (i) diamine units each derived from 4,4′-diaminodiphenylsulfone and (ii) dicarboxylic acid units each derived from terephthalic acid (or halogenated terephthalic acid). Monomers contained in these units are readily available, and also these units are easy to handle.

The wholly aromatic polyamide-based resin which contains, as a main component, the units each represented by Formula (3) may have a structure which is composed of units other than the units each represented by Formula (3). Examples of such a structure include a polyimide backbone.

The wholly aromatic polyamide-based resin containing, as a main component, units each represented by Formula (3) may be used alone, or two or more types of the wholly aromatic polyamide-based resins may be alternatively used in combination.

The wholly aromatic polyamide-based resin containing, as a main component, units each represented by Formula (3) can be synthesized according to a conventional method. For example, the wholly aromatic polyamide-based resin containing, as a main component, units each represented by Formula (3) can be synthesized by polymerizing a diamine represented by NH₂—Ar⁵—NH₂ and a dicarboxylic dihalide represented by X—C(═O)—Ar⁶—C(═O)—X (X is a halogen atom such as F, Cl, Br, and I), according to a publicly known polymerization method for forming an aromatic polyamide.

The meta-aramid represents a wholly aromatic polyamide having an aromatic ring having an amide bond at a meta position. Specific examples of the meta-aramid include poly(metaphenylene terephthalamide), poly(metaphenylene isophthalamide), and the like. Among the above meta-aramids, poly(metaphenylene terephthalamide) is more preferable from athe viewpoint of making it easier to produce the cyclic component. The meta-aramid may be used alone or two or more of the meta-aramids may be alternatively used in combination.

Examples of the resin having an amide bond include a block copolymer including a block A containing, as a main component, units each represented by Formula (1) below, and a block B containing, as a main component, units each represented by Formula (2) below.

—(NH—Ar¹—NHCO—Ar²—CO)— Formula (1)

—(NH—Ar³—NHCO—Ar⁴—CO—)— Formula (2)

where: Ar¹, Ar², Ar³, and Ar⁴ may each vary from unit to unit; Ar¹, Ar², Ar³, and Ar⁴ are each independently a divalent group having one or more aromatic rings; not less than 50% of all Ar¹ each have a structure in which two aromatic rings are connected by a sulfonyl bond; not more than 50% of all Ar³ each have a structure in which two aromatic rings are connected by a sulfonyl bond; and 10% to 70%, preferably 10% to 50% of all Ar' and Ar³ each have a structure in which two aromatic rings are connected by a sulfonyl bond.

Here, in the block copolymer, it is preferable that: not less than 50% of the units which are contained in the block A and which are each represented by Formula (1) are each 4,4′-diphenylsulfonyl terephthalamide; and not less than 50% of the units which are contained in the block B and which are each represented by Formula (2) are each paraphenylene terephthalamide. Moreover, the block copolymer preferably has a triblock structure of the block B—the block A—the block B. Furthermore, it is preferable that: in a molecule corresponding to a mode in a molecular weight distribution of the block copolymer, the block A contains 10 to 1000 units each represented by Formula (1), and the block B contains 10 to 500 units each represented by Formula (2).

Another example of the resin having an amide bond is a polymer which does not contain units each represented by Formula (1) but contains 5 to 200 units each represented by Formula (2).

In an embodiment of the present invention, the resin having an amide bond can be prepared by a polymerization method in which a diamine component and a dicarboxylic dichloride component are used and the monomers are sequentially connected. Here, in a case where a concentration of the monomers in a reaction solvent is low, a condensation reaction between different molecules is less likely to occur, and the connection by the chemical bond is easily interrupted. This makes it easier to produce a low molecular weight chain polymer. Furthermore, in a case where the concentration of the monomers in the reaction solvent is low, a condensation reaction is more likely to occur between both terminals of the same molecule than a condensation reaction between different molecules. From this, the cyclic component is also easily produced. As a result, the “component that is to be eluted into NMP” can be controlled to fall within a suitable range.

Here, in the polymerization method described above, before polymerization, a diamine component is dissolved in a solvent to prepare a monomer solution, and polymerization is initiated when a dicarboxylic dichloride component is further added to the monomer solution. Therefore, lowering the concentration of monomers to be used means that the concentration of the polymer produced is controlled to a low value. In an embodiment of the present invention, a concentration of the monomers in the monomeric solution is preferably 2.0% by weight to 10.0% by weight, and more preferably 3.0% by weight to 8.0% by weight.

Further, in an embodiment of the present invention, a reaction temperature and/or a water content of the reaction solvent are adjusted to suitable ranges in the polymerization of the diamine component and the dicarboxylic dichloride component. Accordingly, an amount of the produced chain polymer whose both terminals are carboxy groups is controlled to fall within a suitable range. As a result, the “component that is to be eluted into NMP” can be controlled to fall within a suitable range.

Specifically, in a case where the reaction temperature in the polymerization reaches a higher temperature, a hydrolysis reaction of dicarboxylic dichloride added is promoted by H₂O which is present in the reaction solvent. This makes it easier to produce a chain polymer whose both terminals are carboxy groups. Meanwhile, in a case where the reaction temperature is excessively high, monomers which are a raw material are decomposed and/or a solvent used in the polymerization reaction is evaporated. In such a case, there is a possibility that the polymerization reaction itself may not occur.

Similarly to the above reason, in a case where the water content is higher, H₂O which is involved in the reaction is increased. Therefore, the hydrolysis reaction is promoted and as a result, a chain polymer whose both terminals are carboxy groups is easily produced. Meanwhile, in a case where the water content is excessively high, monomers are deposited from the monomer solution used in the polymerization reaction. In such a case, there is a possibility that the polymerization reaction itself may not occur.

In an embodiment of the present invention, the reaction temperature is preferably not less than 10° C. and not more than 50° C., and more preferably not less than 20° C. and not more than 40° C. In an embodiment of the present invention, the water content is preferably not less than 50 ppm and not more than 900 ppm, and more preferably not less than 100 ppm and not more than 600 ppm.

As later described in the “Method of producing nonaqueous electrolyte secondary battery laminated separator”, a nonaqueous electrolyte secondary battery porous layer is generally formed by the following method: a coating solution which is obtained by dissolving or dispersing a resin or the like that is a raw material in a solvent such as NMP is applied to a base material to form a coating layer; and then the solvent is removed from the coating layer, and the resin or the like is deposited on the base material.

The “component that is to be eluted into NMP” in an embodiment of the present invention has high solubility in the solvent such as NMP. Therefore, when the porous layer is formed, deposition of the “component that is to be eluted into NMP” is slower than that of the other components. Therefore, the “component that is to be eluted into NMP” is deposited on the surface of the porous layer which is formed.

Here, when a charge-discharge cycle of a nonaqueous electrolyte secondary battery such as a lithium ion secondary battery is repeated, dendrites derived from cations such as lithium ions (Li⁺) which are charge carriers are generated on the electrode, and the dendrites are grown. Note, here, that the grown dendrites may cause damage to the nonaqueous electrolyte secondary battery separator and, as a result, a short circuit can occur.

In contrast, in the nonaqueous electrolyte separator including the porous layer in accordance with an embodiment of the present invention, the “component that is to be eluted into NMP” deposited on the surface of the nonaqueous electrolyte porous layer hinders growth of dendrites. Therefore, it is possible to inhibit occurrence of a short circuit caused by the grown dendrites and to increase the number of charge-discharge cycles until a short circuit occurs. As a result, the nonaqueous electrolyte porous layer in accordance with an embodiment of the present invention brings about an effect of improving durability of a nonaqueous electrolyte secondary battery with respect to charge-discharge cycles.

In the nonaqueous electrolyte porous layer in accordance with an embodiment of the present invention, from the viewpoint of improving durability of the nonaqueous electrolyte secondary battery with respect to charge-discharge cycles, a contained amount of the “component that is to be eluted into NMP” is not less than 6.0% by weight, preferably not less than 8.0% by weight, and more preferably not less than 10.0% by weight, with respect to the total weight of the resin having an amide bond.

Moreover, the “component that is to be eluted into NMP” has high solubility in the solvent, and is less likely to be deposited. Therefore, in a case where the porous layer contains an excessive amount of the “component that is to be eluted into NMP”, the coating solution used for forming the porous layer is to contain an excessive amount of the “component that is to be eluted into NMP” which is less likely to be deposited. As a result, it may be difficult to form the porous layer from the coating layer.

Furthermore, the “component that is to be eluted into NMP” can contain the cyclic component and/or the low molecular weight chain polymer, which are components smaller than the “high molecular weight chain polymer”. Note, here, that the porous layer is typically formed on a porous base material such as a polyolefin porous film. Therefore, in a case where the porous layer contains an excessive amount of the “component that is to be eluted into NMP”, components which are a part of the “component that is to be eluted into NMP” and which are smaller than the “high molecular weight chain polymer” enter holes in the porous base material. As a result, the holes may be blocked, and a resistance value of the nonaqueous electrolyte secondary battery including the porous base material and the porous layer may increase.

From the viewpoint of preventing cases where formation of the porous layer is difficult and the resistance value of the nonaqueous electrolyte secondary battery is increased as described above, in an embodiment of the present invention, the contained amount of the “component that is to be eluted into NMP” is not more than 25.0% by weight, preferably not more than 22.0% by weight, and more preferably not more than 20.0% by weight, with respect to the total weight of the resin having the amide bond.

The contained amount of the “component that is to be eluted into NMP” is not substantially changed by the operations for forming the nonaqueous electrolyte secondary battery porous layer, such as, for example: an operation of preparing a coating solution obtained by dissolving or dispersing a resin or the like which is a raw material in a solvent such as NMP; an operation of coating the base material with the coating solution and forming a coating layer;

and an operation of removing the solvent from the coating layer and depositing the resin or the like on the base material. In other words, in an embodiment of the present invention, the contained amount of the “component that is to be eluted into NMP” in the porous layer is substantially identical with a contained amount of the “component that is to be eluted into NMP” in a composition that contains the resin having an amide bond and that is used to form the porous layer.

Therefore, it is possible to form the porous layer in accordance with an embodiment of the present invention by using, as a raw material, the composition which satisfies the following requirements in which: the resin having an amide bond is contained; the resin having an amide bond contains the “component that is to be eluted into NMP”; and a contained amount of the “component that is to be eluted into NMP” is not less than 6.0% by weight and not more than 25.0% by weight relative to the entire resin having an amide bond.

In an embodiment of the present invention, a contained amount of the resin having an amide bond in the porous layer is preferably 10% by weight to 90% by weight, and more preferably 20% by weight to 70% by weight, with respect to the total weight of the porous layer.

[Filler]

The porous layer in accordance with an embodiment of the present invention can contain a filler.

As to the filler, there are the following types of fillers: organic fillers and inorganic fillers.

Examples of the organic fillers include: homopolymers and copolymers which are each obtained from one or more monomers such as styrene, vinyl ketone, acrylonitrile, methyl methacrylate, ethyl methacrylate, glycidyl methacrylate, glycidyl acrylate, and/or methyl acrylate; fluorine-based resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. Each of these organic fillers may be used alone or two or more of these organic fillers may be alternatively used in combination. Among these organic fillers, a polytetrafluoroethylene powder is preferable in terms of chemical stability.

Examples of the inorganic fillers include materials each made of an inorganic matter such as metal oxide, metal nitride, metal carbide, metal hydroxide, carbonate, or sulfate. Specific examples of the inorganic fillers include: powders of aluminum oxide (such as alumina), boehmite, silica, titania, magnesia, barium titanate, aluminum hydroxide, calcium carbonate, and the like; and minerals such as mica, zeolite, kaolin, and talc. Each of these inorganic fillers may be used alone or two or more of these inorganic fillers may be alternatively used in combination. Among these inorganic fillers, aluminum oxide is preferable in terms of chemical stability.

The shape of each of particles of the filler can be a substantially spherical shape, a plate shape, a columnar shape, a needle shape, a whisker shape, a fibrous shape, or the like. The particles can have any shape. The particles preferably have a substantially spherical shape, because such particles facilitate formation of uniform pores.

The average particle diameter of the filler is preferably 0.01 μm to 1 μm. In this specification, the “average particle diameter of the filler” indicates a volume-based average particle diameter (D50) of the filler. “D50” means a particle diameter having a value at which a cumulative value reaches 50% in a volume-based particle size distribution. D50 can be measured with use of, for example, a laser diffraction particle size analyzer (product names: SALD2200, SALD2300, etc., manufactured by Shimadzu Corporation).

A contained amount of the filler is preferably 20% by weight to 90% by weight, and more preferably 30% by weight to 80% by weight, with respect to the total weight of the porous layer. In a case where the contained amount of the filler falls within the above range, the resulting porous layer has sufficient ion permeability.

[Other Components]

The porous layer in accordance with an embodiment of the present invention may contain a component different from the resin having an amide bond and the filler, as long as such a component does not prevent the object of the present invention from being attained. The other component to be contained may be, for example, a resin different from the resin having an amide bond and an additive which is generally used in a nonaqueous electrolyte secondary battery porous layer. The other component may be one type or may be a mixture of two or more types.

Examples of the resin different from the resin having an amide bond include: polyolefins; (meth)acrylate-based resins; fluorine-containing resins; polyester-based resins; rubbers; resins each having a melting point or a glass transition temperature of not lower than 180° C.; water-soluble polymers; polycarbonates, polyacetals, polyether ether ketones, polybenzimidazoles, polyurethanes, melamine resins, and the like.

Examples of the additive include flame retardants, antioxidants, surfactants, waxes, and the like.

### Embodiment 2: Nonaqueous Electrolyte Secondary Battery Laminated Separator

In the nonaqueous electrolyte secondary battery laminated separator in accordance with Embodiment 2 of the present invention, the porous layer in accordance with Embodiment 1 of the present invention is formed on one surface or both surfaces of the polyolefin porous film. The nonaqueous electrolyte secondary battery laminated separator includes the porous layer in accordance with an embodiment of the present invention. Therefore, the nonaqueous electrolyte secondary battery laminated separator brings about an effect of improving durability of the nonaqueous electrolyte secondary battery including the nonaqueous electrolyte secondary battery laminated separator with respect to charge-discharge cycles.

[Polyolefin Porous Film]

The nonaqueous electrolyte secondary battery laminated separator in accordance with an embodiment of the present invention (hereinafter, simply referred to also as a “laminated separator”) includes a polyolefin porous film. The polyolefin porous film has therein many pores connected to one another. This allows a gas and a liquid to pass through the polyolefin porous film from one side to the other side. The polyolefin porous film can be a base material of the laminated separator. The polyolefin porous film can be one that imparts a shutdown function to the laminated separator by, when a battery generates heat, melting and thereby making the laminated separator non-porous.

Note, here, that a “polyolefin porous film” is a porous film which contains a polyolefin-based resin as a main component. Note that the phrase “contains a polyolefin-based resin as a main component” means that the porous film contains the polyolefin-based resin in a proportion of not less than 50% by volume, preferably not less than 90% by volume, and more preferably not less than 95% by volume, relative to the total amount of materials of which the porous film is made.

The polyolefin-based resin which the polyolefin porous film contains as a main component is not limited to any particular one. Examples of the polyolefin-based resin include homopolymers and copolymers which are each a thermoplastic resin and which are each obtained by polymerizing one or more monomers such as ethylene, propylene, 1-butene, 4-methyl-1-pentene, and/or 1-hexene. Specific examples of the homopolymers include polyethylene, polypropylene, and polybutene. Specific examples of the copolymers include an ethylene-propylene copolymer. The polyolefin porous film can be a layer which contains one type of polyolefin-based resin or can be alternatively a layer which contains two or more types of polyolefin-based resins. Among these polyolefin-based resins, polyethylene is more preferable because polyethylene makes it possible to prevent (shut down) a flow of an excessively large electric current at a lower temperature, and high molecular weight polyethylene which contains ethylene as a main component is particularly preferable. Note that the polyolefin porous film can contain a component other than polyolefin, provided that the component does not impair the function of the polyolefin porous film.

Examples of the polyethylene include low-density polyethylene, high-density polyethylene, linear polyethylene (ethylene-α-olefin copolymer), and ultra-high molecular weight polyethylene. Among these polyethylenes, ultra-high molecular weight polyethylene is more preferable, and ultra-high molecular weight polyethylene which contains a high molecular weight component having a weight-average molecular weight of 5×10⁵ to 15×10⁶ is still more preferable. In particular, the polyolefin-based resin which contains a high molecular weight component having a weight-average molecular weight of not less than 1,000,000 is more preferable, because such a polyolefin-based resin allows the polyolefin porous film and the nonaqueous electrolyte secondary battery laminated separator to each have increased strength.

The polyolefin porous film has a thickness of preferably 5 μm to 20 μm, more preferably 7 μm to 15 μm, and further preferably 9 μm to 15 μm. The polyolefin porous film which has a thickness of not less than 5 μm can sufficiently achieve functions (such as a function of imparting the shutdown function) which the polyolefin porous film is required to have. The polyolefin porous film which has a thickness of not more than 20 μm allows the resulting laminated separator to be thinner.

The pores in the polyolefin porous film each have a diameter of preferably not more than 0.1 μm, and more preferably not more than 0.06 μm. This makes it possible for the nonaqueous electrolyte secondary battery laminated separator to achieve sufficient ion permeability. Furthermore, this makes it possible to more prevent particles, which constitute an electrode, from entering the polyolefin porous film.

The polyolefin porous film typically has a weight per unit area of preferably 4 g/m² to 20 g/m², and more preferably 5 g/m² to 12 g/m², so as to allow a battery to have a higher weight energy density and a higher volume energy density.

The polyolefin porous film has an air permeability of preferably 30 s/100 mL to 500 s/100 mL, and more preferably 50 s/100 mL to 300 s/100 mL, in terms of Gurley values. This allows the laminated separator to achieve sufficient ion permeability.

The polyolefin porous film has a porosity of preferably 20% by volume to 80% by volume, and more preferably 30% by volume to 75% by volume. This makes it possible to (i) increase the amount of an electrolyte retained in the polyolefin porous film and (ii) absolutely prevent (shut down) a flow of an excessively large electric current at a lower temperature.

A method of producing the polyolefin porous film is not limited to a particular method, and any publicly known method can be employed. For example, a method can be employed which involves adding a filler to a thermoplastic resin, forming a resulting mixture into a film, and then removing the filler, as disclosed in Japanese Patent No. 5476844.

Specifically, when, for example, the polyolefin porous film is made of the polyolefin-based resin which contains ultra-high molecular weight polyethylene and low molecular weight polyolefin that has a weight-average molecular weight of not more than 10,000, the polyolefin porous film is preferably produced by, from the viewpoint of production costs, a method including the following steps (1) through (4):

(1) kneading 100 parts by weight of ultra-high molecular weight polyethylene, 5 parts by weight to 200 parts by weight of low molecular weight polyolefin which has a weight-average molecular weight of not more than 10,000, and 100 parts by weight to 400 parts by weight of an inorganic filler such as calcium carbonate to obtain a polyolefin-based resin composition;

(2) forming the polyolefin-based resin composition into a sheet;

(3) removing the inorganic filler from the sheet which has been obtained in the step (2); and

(4) stretching the sheet which has been obtained in the step (3).

Alternatively, the polyolefin porous film may be produced by a method disclosed in any of the above-listed Patent Literatures.

The polyolefin porous film can be alternatively a commercially available product which has the above-described characteristics.

[Physical Properties of Nonaqueous Electrolyte Secondary Battery Laminated Separator]

The laminated separator has an air permeability of preferably not more than 500 s/100 mL, and more preferably not more than 300 s/100 mL, in terms of Gurley values. The porous layer included in the laminated separator has an air permeability of preferably not more than 400 s/100 mL, and more preferably not more than 200 s/100 mL, in terms of Gurley values. When the air permeabilities of the laminated separator and the porous layer fall within the above respective ranges, the laminated separator and the porous layer each have sufficient ion permeability.

The air permeability of the porous layer is calculated by Y−X, where X represents the air permeability of the polyolefin porous film and Y represents the air permeability of the laminated separator. The air permeability of the porous layer can be adjusted by, for example, adjusting the intrinsic viscosity of one or more of the resins and/or the weight per unit area of the porous layer. Generally, as the intrinsic viscosity of a resin decreases, a Gurley value tends to decrease. As the weight per unit area of a porous layer decreases, a Gurley value tends to decrease.

The porous layer included in the laminated separator has a thickness of preferably not more than 10 μm, more preferably not more than 7 μm, and still more preferably not more than 5 μm.

In addition to the polyolefin porous film and the porous layer, the laminated separator may have another layer as necessary. Examples of such a layer include an adhesive layer and a protective layer.

[Method of Producing Nonaqueous Electrolyte Secondary Battery Laminated Separator]

The laminated separator can be produced by forming the porous layer with use of a coating solution obtained by dissolving or dispersing the resin having an amide bond and optionally a filler in a solvent. Examples of a method of forming the coating solution include a mechanical stirring method, an ultrasonic dispersion method, a high-pressure dispersion method, and a media dispersion method. The solvent can be, for example, N-methylpyrrolidone, N,N-dimethylacetamide, N,N-dimethylformamide, or the like.

A method of producing the laminated separator can be, for example, a method which involves preparing the coating solution, applying the coating solution to the polyolefin porous film, and then drying the coating solution so that the porous layer is formed on the polyolefin porous film.

As a method of coating the polyolefin porous film with the coating solution, a publicly known coating method, such as a knife coater method, a blade coater method, a bar coater method, a gravure coater method, or a die coater method, can be employed.

The solvent (dispersion medium) is generally removed by a drying method. Examples of the drying method include natural drying, air-blow drying, heat drying, and drying under reduced pressure. Note, however, that any method can be employed, provided that the solvent (dispersion medium) can be sufficiently removed. Note also that drying can be carried out after the solvent (dispersion medium) contained in the coating material is replaced with another solvent. A method of replacing the solvent (dispersion medium) with another solvent and then removing the another solvent can be specifically as follows: (i) the solvent (dispersion medium) is replaced with a poor solvent having a low boiling point, such as water, alcohol, or acetone, (ii) a solute is deposited, and (iii) drying is carried out.

### Embodiment 3: Nonaqueous Electrolyte Secondary Battery Member, and Embodiment 4: Nonaqueous Electrolyte Secondary Battery

A nonaqueous electrolyte secondary battery member in accordance with Embodiment 3 of the present invention includes a positive electrode, the nonaqueous electrolyte secondary battery laminated separator in accordance with Embodiment 2, and a negative electrode which are disposed in this order. A nonaqueous electrolyte secondary battery in accordance with Embodiment 4 of the present invention includes the nonaqueous electrolyte secondary battery laminated separator in accordance with Embodiment 2 of the present invention.

Therefore, the nonaqueous electrolyte secondary battery member in accordance with an embodiment of the present invention and the nonaqueous electrolyte secondary battery in accordance with an embodiment of the present invention both bring about an effect of achieving excellent durability with respect to charge-discharge cycles.

The nonaqueous electrolyte secondary battery in accordance with an embodiment of the present invention typically has a structure in which a negative electrode and a positive electrode face each other with the laminated separator sandwiched therebetween. The nonaqueous electrolyte secondary battery is configured such that a battery element, which includes the structure and an electrolyte with which the structure is impregnated, is enclosed in an exterior member. The nonaqueous electrolyte secondary battery is, for example, a lithium ion secondary battery which achieves an electromotive force through doping with and dedoping of lithium ions.

[Positive Electrode]

Examples of the positive electrode include a positive electrode sheet having a structure in which an active material layer including a positive electrode active material and a binding agent is formed on a current collector. The active material layer may further contain an electrically conductive agent.

Examples of the positive electrode active material include materials each capable of being doped with and dedoped of lithium ions.

Examples of the materials include lithium complex oxides each containing at least one type of transition metal such as V, Ti, Cr, Mn, Fe, Co, Ni, and/or Cu. Examples of the lithium complex oxides include lithium complex oxides each having a layer structure, lithium complex oxides each having a spinel structure, and solid solution lithium-containing transition metal oxides each constituted by a lithium complex oxide having both a layer structure and a spinel structure. Examples of the lithium complex oxides also include lithium cobalt complex oxides and lithium nickel complex oxides. Further, examples of the lithium complex oxides also include lithium complex oxides each obtained by substituting one or more of transition metal atoms, which constitute a large part of any of the above lithium complex oxides, with another or other elements such as Na, K, B, F, Al, Ti, V, Cr, Mn, Fe, Co, Ni, Cu, Zn, Mg, Ca, Ga, Zr, Si, Nb, Mo, Sn, and/or W.

Examples of the lithium complex oxides each obtained by substituting one or more of transition metal atoms, which constitute a large part of any of the above lithium complex oxides, with another or other elements include: lithium cobalt complex oxides each having a layer structure and each represented by Formula (4) below; lithium nickel complex oxides each represented by Formula (5) below; lithium-manganese complex oxides each having a spinel structure and each represented by Formula (6) below; and solid solution lithium-containing transition metal oxides each represented by Formula (7) below.

Li[Liₓ(Co₁₋ₐM¹ₐ)₁₋ₓ]O₂ Formula (4)

where: M¹ is at least one type of metal selected from the group consisting of Na, K, B, F, Al, Ti, V, Cr, Mn, Fe, Ni, Cu, Zn, Mg, Ga, Zr, Si, Nb, Mo, Sn, and W; and −0.1≤x≤0.30 and 0≤a≤0.5 are satisfied.

Li[Li_{y}(Ni_{1-b}M²_{b})_{1-y}]O₂ Formula (5)

where: M² is at least one type of metal selected from the group consisting of Na, K, B, F, Al, Ti, V, Cr, Mn, Fe, Co, Cu,

Zn, Mg, Ga, Zr, Si, Nb, Mo, Sn, and W; and -0.1 y 0.30 and 0≤b≤0.5 are satisfied.

Li_{z}Mn_{2-c}M³_{c}O₄ Formula (6)

where: M³ is at least one type of metal selected from the group consisting of Na, K, B, F, Al, Ti, V, Cr, Fe, Co, Ni, Cu, Zn, Mg, Ga, Zr, Si, Nb, Mo, Sn, and W; and 0.9≤z and 0≤c≤1.5 are satisfied.

Li₁₊₂M⁴_{d}M⁵ₑO₂ Formula (7)

where: M⁴ and M⁵ are each independently at least one type of metal selected from the group consisting of Al, Ti, V, Cr, Mn, Fe, Co, Ni, Cu, Zn, Mg, and Ca; and 0<w≤1/3, 0≤d≤2/3, 0≤e≤2/3, and w+d+e=1 are satisfied.

Specific examples of the lithium complex oxides represented by Formulae (4) to (7) include LiCoO₂, LiNiO₂, LiMnO₂, LiNi0.8Co_{0.2}O₂, LiNi_{0.5}Mn_{0.5}O₂, LiNi_{0.85}Co_{0.10}Al_{0.05}O₂, LiNi_{0.8}Co_{0.15}Al_{0.05}O₂, LiNi_{0.5}Co_{0.2}Mn_{0.3}O₂, LiNi_{0.6}Co_{0.2}Mn_{0.2}O₂, LiNi_{0.33}Co_{0.33}Mn_{0.33}O₂, LiMn₂O₄, LiMn_{1.5}Ni_{0.5}O₄, LiMn_{1.5}Fe_{0.5}O₄, LiCoMnO₄, Li_{1.21}Ni_{0.20}Mn_{0.59}O₂, Li_{1.22}Ni_{0.20}Mn_{0.58}O₂, Li_{1.22}Ni_{0.15}Co_{0.10}Mn_{0.53}O₂, Li_{1.07}Ni_{0.35}Co_{0.08}Mn_{0.50}O₂, and Li_{1.07}Ni_{0.36}Co_{0.08}Mn_{0.49}O₂.

Lithium complex oxides other than the lithium complex oxides represented by Formulae (4) to (7) can be also preferably used as the positive electrode active material. Examples of such lithium complex oxides include LiNiVO₄, LiV₃O₆, and Li_{1.2}Fe_{0.4}Mn_{0.4}O₂.

Examples of a material which can be preferably used as the positive electrode active material, other than the lithium complex oxides, include phosphates each having an olivine-type structure. Specific examples of such phosphates include phosphates each having an olivine-type structure and each represented by the following Formula (8).

Liᵥ(M⁶_{f}M⁷_{g}M⁸ₕM⁹ᵢ)ⱼPO₄ Formula (8)

where: M⁶ is Mn, Co, or Ni; M⁷ is Ti, V, Cr, Mn, Fe, Co, Ni, Zr, Nb, or Mo; M⁸ is a transition metal, optionally excluding the elements in the groups VIA and VIIA, or a representative element; M⁹ is a transition metal, optionally excluding the elements in the groups VIA and VIIA, or a representative element; and 1.2≥a≥0.9, 1≥b≥0.6, 0.4≥c≥0, 0.2≥d≥0, 0.2≥e≥0, and 1.2≥f≥0.9 are satisfied.

In the positive electrode active material, each of surfaces of lithium metal complex oxide particles constituting the positive electrode active material is preferably coated with a coating layer. Examples of a material of which the coating layer is made include metal complex oxides, metal salts, boron-containing compounds, nitrogen-containing compounds, silicon-containing compounds, and sulfur-containing compounds. Among these materials, metal complex oxides are suitably used.

The metal complex oxides are preferably oxides each having lithium ion conductivity. Examples of such metal complex oxides include metal complex oxides of Li and at least one type of element selected from the group consisting of Nb, Ge, Si, P, Al, W, Ta, Ti, S, Zr, Zn, V, and B. When the positive electrode active material is a material particles of which each have a coating layer, the coating layer suppresses a side reaction which occurs at the interface between the positive electrode active material and the electrolyte substance at high voltages, and the resulting secondary battery can achieve a longer life. Moreover, the coating layer suppresses formation of a high-resistance layer at the interface between the positive electrode active material and the electrolyte substance, and the resulting secondary battery can achieve high output.

Examples of the electrically conductive agent include carbonaceous materials such as natural graphite, artificial graphite, cokes, carbon black, pyrolytic carbons, carbon fibers, and fired products of organic polymer compounds.

Examples of the binding agent include: thermoplastic resins such as polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, thermoplastic polyimide, polyethylene, and polypropylene; acrylic resins; and styrene-butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet include: a method which involves pressure-molding, on the positive electrode current collector, the positive electrode active material, the electrically conductive agent, and the binding agent which constitute a positive electrode mix; and a method which involves (i) forming, into a paste, the positive electrode active material, the electrically conductive agent, and the binding agent with use of an appropriate organic solvent to obtain the positive electrode mix, (ii) coating the positive electrode current collector with the positive electrode mix, (iii) drying the positive electrode mix, and then (iv) pressuring the resulting sheet-shaped positive electrode mix on the positive electrode current collector so that the sheet-shaped positive electrode mix is firmly fixed to the positive electrode current collector.

[Negative Electrode]

The negative electrode can be, for example, a negative electrode sheet having a structure in which an active material layer, containing a negative electrode active material and a binding agent, is formed on a current collector. The active material layer may further contain an electrically conductive agent.

Examples of the negative electrode active material include carbon materials, chalcogen compounds (such as oxides and sulfides), nitrides, metals, and alloys each of which is capable of being doped with and dedoped of lithium ions at electric potentials lower than that of the positive electrode.

Examples of the carbon materials which can be used as the negative electrode active material include graphites such as natural graphite and artificial graphite, cokes, carbon black, pyrolytic carbons, carbon fibers, and fired products of organic polymer compounds.

Examples of the oxides which can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VₓO_{y} (where x and y are each a positive real number), such as V₂O₅ and VO₂; oxides of iron which are represented by a formula FeOₓO_{y} (where x and y are each a positive real number), such as Fe₃O₄, Fe₂O₃, and FeO; oxides of tin which are represented by a formula SnOₓ (where x is a positive real number) such as SnO₂ and SnO; oxides of tungsten which are represented by a general formula WOₓ (where x is a positive real number) such as WO₃ and WO₂; and complex metal oxides each of which contains lithium and titanium or vanadium, such as Li₄Ti₅O₁₂ and LiVO₂.

Examples of the sulfides which can be used as the negative electrode active material included: sulfides of titanium which are represented by a formula TiₓS_{y} (where x and y are each a positive real number), such as Ti₂S₃, TiS₂, and TiS; sulfides of vanadium which are represented by a formula VSₓ (where x is a positive real number), such as V₃5₄, VS₂, and VS; sulfides of iron which are represented by a formula FeₓS_{y} (where x and y are each a positive real number), such as Fe₃S₄, FeS₂, and FeS; sulfides of molybdenum which are represented by a formula MoₓS_{y} (where x and y are each a positive real number), such as Mo₂S₃ and MoS₂; sulfides of tin which are represented by a formula SnSₓ (where x is a positive real number) such as SnS₂ and SnS; sulfides of tungsten which are represented by a formula WSₓ (where x is a positive real number), such as WS₂; sulfides of antimony which are represented by a formula SbₓS_{y} (where x and y are each a positive real number), such as Sb₂S₃; and sulfides of selenium which are represented by a formula SeₓS_{y} (where x and y are each a positive real number), such as Se₅S₃, SeS₂, and SeS.

Examples of the nitrides which can be used as the negative electrode active material include lithium-containing nitrides such as Li₃N and Li₃₋ₓAₓN (where A is one or both of Ni and Co, and 0<x<3 is satisfied).

Each of these carbon materials, oxides, sulfides, and nitrides may be used alone or two or more of these carbon materials, oxides, sulfides, and nitrides may be used in combination. These carbon materials, oxides, sulfides, and nitrides can be each crystalline or amorphous. One or more of these carbon materials, oxides, sulfides, and nitrides are mainly supported by the negative electrode current collector, and the resulting negative electrode current collector is used as an electrode.

Examples of the metals which can be used as the negative electrode active material include lithium metals, silicon metals, and tin metals.

It is also possible to use a complex material which contains Si or Sn as a first constituent element and also contains second and/or third constituent elements. The second constituent element is, for example, at least one type of element selected from cobalt, iron, magnesium, titanium, vanadium, chromium, manganese, nickel, copper, zinc, gallium, and zirconium. The third constituent element is, for example, at least one type of element selected from boron, carbon, aluminum, and phosphorus.

In particular, since a high battery capacity and excellent battery characteristics are achieved, the above metal material is preferably a simple substance of silicon or tin (which may contain a slight amount of impurities), SiOᵥ (0<v≤2), SnO_{w} (0≤w≤2), an Si—Co—C complex material, an Si—Ni—C complex material, an Sn—Co—C complex material, or an Sn—Ni—C complex material.

Examples of the negative electrode current collector include Cu, Ni, and stainless steel. Among these materials,

Cu is more preferable because Cu is not easily alloyed with lithium particularly in a lithium-ion secondary battery and is easily processed into a thin film.

Examples of a method of producing the negative electrode sheet include: a method which involves pressure-molding, on the negative electrode current collector, the negative electrode active material which constitutes a negative electrode mix; and a method which involves (i) forming the negative electrode active material into a paste with use of an appropriate organic solvent to obtain the negative electrode mix, (ii) coating the negative electrode current collector with the negative electrode mix, (iii) drying the negative electrode mix, and then (iv) pressing the resulting sheet-shaped negative electrode mix on the negative electrode current collector so that the sheet-shaped negative electrode mix is firmly fixed to the negative electrode current collector. The paste preferably contains an electrically conductive agent as described above and a binding agent as described above.

[Nonaqueous Electrolyte]

The nonaqueous electrolyte can be, for example, a nonaqueous electrolyte obtained by dissolving a lithium salt in an organic solvent. Examples of the lithium salt include LiClO₄, LiPF₆, LiAsF₆, LiSbF₆, LiBF₄, LiSO₃F, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (BOB refers to bis(oxalato)borate), lower aliphatic carboxylic acid lithium salt, and LiAlCl₄. Each of these lithium salts may be used alone or two or more of these lithium salts may be used as a mixture. Among these lithium salts, it is preferable to use at least one fluorine-containing lithium salt selected from the group consisting of LiPF₆, LiAsF₆, LiSbF₆, LiBF₄, LiSO₃F, LiCF₃SO₃, LiN(SO₂CF₃)₂, and LiC(SO₂CF₃)₃.

Examples of the organic solvent include carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and compounds each prepared by introducing a fluoro group into any of these organic solvents (i.e., compounds each prepared by substituting one or more hydrogen atoms of any of these organic solvents with one or more respective fluorine atoms).

The organic solvent is preferably a mixed solvent obtained by mixing two or more of the above organic solvents. Particularly, the organic solvent is preferably a mixed solvent containing a carbonate, further preferably a mixed solvent containing a cyclic carbonate and an acyclic carbonate or a mixed solvent containing a cyclic carbonate and an ether. The mixed solvent containing a cyclic carbonate and an acyclic carbonate is preferably a mixed solvent containing ethylene carbonate, dimethyl carbonate, and ethyl methyl carbonate. The nonaqueous electrolyte which contains such a mixed solvent has advantages of having a wider operating temperature range, being less prone to deterioration even when used at a high voltage, being less prone to deterioration even when used for a long period of time, and less prone to decomposition even when the negative electrode active material is a graphite material such as natural graphite or artificial graphite.

It is preferable to use, as the nonaqueous electrolyte, a nonaqueous electrolyte containing (i) a lithium salt containing fluorine (such as LiPF₆) and (ii) an organic solvent containing a fluorine substituent, because such a nonaqueous electrolyte allows the resulting nonaqueous electrolyte secondary battery to have increased safety. It is further preferable to use a mixed solvent containing a dimethyl carbonate and an ether having a fluorine substituent (such as pentafluoropropyl methylether or 2,2,3,3-tetrafluoropropyl difluoro methylether), because such a mixed solvent allows the resulting nonaqueous electrolyte secondary battery to have a high capacity maintenance ratio even when the nonaqueous electrolyte secondary battery is discharged at a high voltage.

[Method of Producing Nonaqueous Electrolyte Secondary Battery Member and Method of Producing Nonaqueous Electrolyte Secondary Battery]

A method of producing the nonaqueous electrolyte secondary battery member can be, for example, a method which involves disposing the positive electrode, the nonaqueous electrolyte secondary battery laminated separator in accordance with an embodiment of the present invention, and the negative electrode in this order.

A method of producing the nonaqueous electrolyte secondary battery can be, for example, the following method. First, the nonaqueous electrolyte secondary battery member is placed in a container which is to be a housing of the nonaqueous electrolyte secondary battery. Next, the container is filled with the nonaqueous electrolyte, and then the container is hermetically sealed while pressure inside the container is reduced. In this manner, it is possible to produce the nonaqueous electrolyte secondary battery.

The present invention is not limited to the embodiments, but can be altered variously by a skilled person in the art within the scope of the claims. The present invention also encompasses, in its technical scope, any embodiment derived by appropriately combining technical means disclosed in differing embodiments. Examples

The following description will discuss embodiments of the present invention in more detail with reference to Examples and Comparative Example. Note, however, that the present invention is not limited to such Examples and Comparative Example.

[Methods of Measuring Various Physical Property Values]

Physical property values of a porous layer, a laminated separator including the nonporous layer, and a nonaqueous electrolyte secondary battery which were prepared in Examples and Comparative Example described later were measured by methods below.

[Thickness]

Thicknesses of the laminated separator and the porous film were measured with the use of a high-precision digital measuring device (VL-50) manufactured by Mitutoyo Corporation. Further, a difference between the thickness of the laminated separator and the thickness of the porous film was calculated, and the difference was regarded as a thickness of the porous layer.

[Weight Per Unit Area]

In advance, a sample in the form of an 8 cm square was cut out from each of porous films which had been used in Examples and Comparative Example described later, and a weight W(g) of the sample was measured. Then, a weight per unit area of the porous film was calculated according to the following Formula (9).

Weight per unit area of porous film (g/m²)=W/(0.08×0.08) Formula (9)

Similarly, a sample in the form of an 8 cm square was cut out from the laminated separator, and a weight W(g) of the sample was measured. Then, a weight per unit area of the laminated separator was calculated according to the following Formula (10).

Weight per unit area (g/m²) of laminated separator=W/(0.08×0.08) Formula (10)

A weight per unit area of the porous layer was calculated according to the following Formula (11) with use of the weight per unit area of the laminated separator and the weight per unit area of the porous film.

Weight per unit area (g/m²) of porous layer=(weight per unit area of laminated separator)−(weight per unit area of porous film) Formula (11)

[Air Permeability]

The air permeability (Gurley value) of the laminated separator was measured in conformity to JIS P8117.

[Contained Amount of Component that is to be Eluted into NMP]

In Examples and Comparative Example described later, first, for a composition which was prepared as a raw material of the porous layer and which was made of a resin having an amide bond, a contained amount of a component that is contained in the composition and that is to be eluted into NMP was measured by a method described below. Subsequently, a laminated separator including the porous layer and a nonaqueous electrolyte secondary battery including the laminated separator were produced by a method described later, and a short circuit time was measured. After that, the laminated separator was taken out from the nonaqueous electrolyte secondary battery. For the laminated separator, a contained amount of a component that is contained in the porous layer and that is to be eluted into NMP was measured by the following method.

A weight of the composition and a weight of the laminated separator were measured. Here, in measuring the contained amount of the component that is contained in the composition and that is to be eluted into NMP, the weight of the composition was regarded as a “weight of the resin having an amide bond”.

From each of the compositions obtained in Examples and Comparative Example described later, 0.50 g of the composition was weighed and collected. 0.50 g of the collected composition was immersed in 1 mL of NMP in an LC vial. The liquid in the LC vial was appropriately stirred, and 5 days later, the extraction solution was filtered with a PTFE membrane filter having a pore diameter of 0.45 μm to obtain a filtrate A. Meanwhile, a powdery composition which was identical with the composition immersed in NMP and whose amount was 20 times the amount of the composition immersed in NMP was dissolved in 20 mL of NMP. After that, the mixture was filtered with a PTFE membrane filter having a pore diameter of 0.45 μm to obtain a filtrate B. For each of the filtrate A and the filtrate B, a size exclusion chromatography (SEC) analysis was carried out under the following conditions. A device used was equivalent to LC-20A manufactured by Shimadzu Corporation. A column was made by connecting two TSK-GEL SUPER AWM-H manufactured by Tosoh Corporation. NMP in which 30 mM of LiBr was dissolved was used as an eluting solution. A flow rate was 0.4 mL/min. A column temperature was 40° C. Detection was carried out with UV having a wavelength of 310 nm. An “area value of composition immersion solution” and an “area value of reference solution” were calculated from chromatograms respectively obtained from the filtrate A and the filtrate B. Note that the “area value of composition immersion solution” is an area value in a chromatogram obtained using the filtrate A. The “area value of reference solution” is an area value in a chromatogram obtained using the filtrate B.

A contained amount of the component that is to be eluted into NMP was calculated according to the following Formula (12) with use of the “area value of composition immersion solution” and the “area value of reference solution” obtained by the above operation.

Contained amount of component that is to be eluted into NMP (% by weight)=Area value of composition immersion solution/Area value of reference solution Formula (12)

The separator was cut with a razor to prepare six separators each having a size of 1 cm×2 cm, and the pieces were immersed in 1 mL of NMP in an LC vial. The liquid in the LC vial was appropriately stirred, and 5 days later, the extraction solution was filtered with a PTFE membrane filter having a pore diameter of 0.45 μm to obtain a filtrate A′. Meanwhile, an amount of the resin composition in the separator which had been immersed in NMP was calculated from a weight per unit area of the porous layer, and a powdery composition which was identical with the resin composition immersed in NMP and whose amount was 20 times the amount of the composition immersed in NMP was dissolved in 20 mL of NMP. After that, the mixture was filtered with a PTFE membrane filter having a pore diameter of 0.45 pm to obtain a filtrate B′. For each of the filtrate A′ and the filtrate B′, a size exclusion chromatography (SEC) analysis was carried out under the following conditions. A device used was equivalent to LC-20A manufactured by Shimadzu Corporation. A column was made by connecting two TSK-GEL SUPER AWM-H manufactured by Tosoh Corporation. NMP in which 30 mM of LiBr was dissolved was used as an eluting solution. A flow rate was 0.4 mL/min. A column temperature was 40° C. Detection was carried out with UV having a wavelength of 310 nm. An “area value of separator immersion solution” and an “area value of powder solution” were calculated from chromatograms respectively obtained from the filtrate A′ and the filtrate B′. Note that the “area value of separator immersion solution” is an area value in a chromatogram obtained using the filtrate A′. The “area value of powder solution” is an area value in a chromatogram obtained using the filtrate B′.

A contained amount of the component that is to be eluted into NMP was calculated according to the following Formula (12′) with use of the “area value of separator immersion solution” and the “area value of powder solution” obtained by the above operation.

Contained amount of component that is to be eluted into NMP (% by weight)=Area value of separator immersion solution/Area value of powder solution Formula (12′)

[Short Circuit Time]

<Preparation of Nonaqueous Electrolyte Secondary Battery for Test>

A nonaqueous electrolyte secondary battery for a test was produced by a method shown in the following steps 1 through 4 with use of nonaqueous electrolyte secondary battery laminated separators obtained in Examples and Comparative Example described later.

1. A positive electrode and a negative electrode were prepared. Both electrodes were each an Li metal electrode (diameter: 15 mm, thickness: 0.5 mm, manufactured by Honjo Metal Co., Ltd.)
2. A nonaqueous electrolyte secondary battery member was produced. In a 2032 coin cell, an SUS spacer, an Li metal electrode, two laminated separators, an Li metal electrode, and an SUS spacer were disposed in this order. In so doing, the laminated separators were disposed such that the porous layers of both the laminated separators make contact with the Li metal electrodes, respectively.
3. The nonaqueous electrolyte secondary battery member was accommodated in the 2032 coin cell, and 180 μL of a nonaqueous electrolyte was injected. After vacuum impregnation, 85 μL of a nonaqueous electrolyte was further injected. The nonaqueous electrolyte was one that had been prepared by dissolving LiPF₆ at a concentration of 1 mol/L in a mixed solvent obtained by mixing ethylene carbonate, ethyl methyl carbonate, and diethyl carbonate at a ratio of 3:5:2 (volume ratio).
4. The coin cell was caulked, and thus a nonaqueous electrolyte secondary battery for a test was prepared.

<Measurement of Short Circuit Time>

The nonaqueous electrolyte secondary battery for the test was subjected to a charge-discharge cycle test under the following conditions.

Test conditions: Current density was 1 mA/cm², duration was 1 h, and capacitance was 1 mAh/cm².
End condition: Overvoltage reaches ±1 V or 0 V (short circuit)

The number of cycles until the overvoltage became ±1 V or 0 V, and lithium dendrites remarkably grew or a short circuit was caused by lithium dendrites was measured and regarded as a short circuit time.

### EXAMPLE 1

<Preparation of Composition>

A composition was prepared by a method which included the following steps (a) through (g).

(a) A 5-L separable flask having a stirring blade, a thermometer, a nitrogen incurrent canal, and a powder addition port was sufficiently dried.

(b) 4217 g of NMP was introduced into the flask. Further, 324.22 g of calcium chloride (which had been dried at 200° C. for 2 hours) was added, and a resulting mixture was heated to 100° C. The calcium chloride was completely dissolved to obtain a solution of calcium chloride. Here, in the solution of calcium chloride, a concentration of calcium chloride was 7.14% by weight, and a water content was adjusted to be 500 ppm.

(c) To the solution of calcium chloride, 151.559 g of 4,4′-diaminodiphenylsulfone (DDS) was added while the temperature was maintained at 100° C., and the DDS was completely dissolved to obtain a solution A(1).

(d) The resulting solution A(1) was cooled to 40° C. After that, to the solution A(1) which had been cooled, a total of 123.304 g of terephthalic acid dichloride (TPC) was added in three separate portions while the temperature was maintained at 40±2° C. A reaction was then caused to occur for 1 hour, and a reaction solution A(1) was obtained. In the reaction solution A(1), a block A(1) which was constituted by poly(4,4′-diphenylsulfonyl terephthalamide) was prepared.

(e) To the reaction solution A(1) obtained, 66.003 g of paraphenylenediamine (PPD) was added, and completely dissolved over 1 hour to obtain a solution B(1).

(f) To the solution B(1), a total of 123.049 g of TPC was added in three separate portions while the temperature was maintained at 40±2° C. A reaction was then caused to occur for 1.5 hours, and a reaction solution B(1) was obtained. In the reaction solution B(1), blocks B(1), each of which was constituted by poly(paraphenylene terephthalamide), extended on both sides of the block A(1).

(g) While the temperature of the reaction solution B(1) was maintained at 40±2° C., the solution was matured for 1 hour. After that, the solution was stirred for 1 hour under reduced pressure, and air bubbles were removed. As a result, a solution was obtained which contained a block copolymer (1) in which the block A(1) accounted for 50% of the entirety of a molecule and the block B(1) accounted for the remaining 50% of the entirety of the molecule. The block copolymer (1) is a resin having an amide bond.

Note that, in Example 1, the weight of the block A(1) relative to the weight of the reaction solution A(1) was 4.82% by weight.

In another flask different from the separable flask, 0.5 L of ion-exchange water was introduced. Further, 50 mL of the solution containing the block copolymer (1) was weighed and collected. After that, 50 mL of the collected solution containing the block copolymer (1) was added to said another flask, and the block copolymer (1) was deposited. The deposited block copolymer (1) was separated by a filtration operation to obtain a composition (1) which was constituted by 3.75 g of the block copolymer (1). Note that, in the filtration operation, the solution remained after the deposition of the block copolymer (1) was filtered once, and then 100 mL of ion-exchange water was added to the resulting deposit and filtration was carried out again. That is, filtration was carried out twice.

0.50 g of the obtained composition (1), i.e., the block copolymer (1) was weighed and collected, and with use of the collected 0.50 g of the block copolymer (1), a contained amount of a component that is contained in the composition and that is to be eluted into NMP was measured by the above described method.

<Preparation of Porous Layer and Laminated Separator>

With use of a remaining solution of the solution containing the block copolymer (1) which had not been used for measurement of the contained amount of the component that is to be eluted into NMP, a porous layer and a laminated separator were prepared by a method described below.

To 4000 g of the solution containing the block copolymer (1), 8.56 L of NMP was added, and a solution in which the block copolymer (1) was dissolved and dispersed was obtained. To the solution in which the block copolymer (1) had been dissolved and dispersed, 300.0 g of aluminum oxide (average particle diameter: 0.013 μm) was added. A resulting mixture was uniformly dispersed with use of a pressure type disperser to prepare a coating solution. A solid content concentration of the coating solution was 5% by weight.

The coating solution was applied to a polyethylene porous film (thickness: 10 μm, weight per unit area: 5.6 g/m²), and the polyethylene porous film to which the coating solution was applied was treated in an oven at 50° C. and a humidity of 70% for 2 minutes so that a porous layer was formed. After that, the resulting polyethylene porous film and porous layer were washed with water and dried to obtain a laminated separator including the porous layer.

Physical property values of the porous layer and the laminated separator were measured by the above described methods. Moreover, with use of the laminated separator, a short circuit time and a contained amount of a component that is contained in the porous layer and that is to be eluted into NMP were measured by the above described method.

### EXAMPLE 2

A reaction solution A(2), a solution containing a block copolymer (2) in which the block A(2) accounted for 50% of the entirety of a molecule and the block B(2) accounted for the remaining 50% of the entirety of the molecule, and a composition (2) constituted by 3.5 g of the block copolymer (2) were obtained in a manner similar to that in Example 1, except that the amount of DDS used in the step (c) was changed to 140.659 g, the total amount of TPC used in each of the steps (d) and (f) was changed to 227.942 g, and the amount of PPD used in the step (f) was changed to 61.259 g. Note that, in

Example 2, the weight of the block A(2) relative to the weight of the reaction solution A(2) was 4.48% by weight.

A contained amount of a component that is contained in the composition and that is to be eluted into NMP was measured in a manner similar to that in Example 1, except that the composition (2) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in Example 1, except that a solution containing the block copolymer (2) was used instead of the solution containing the block copolymer (1), and that the amount of NMP used was changed to 6.83 L and the amount of aluminum oxide used was changed to 280.0 g.

### EXAMPLE 3

A reaction solution A(3), a solution containing a block copolymer (3) in which the block A(3) accounted for 50% of the entirety of a molecule and the block B(3) accounted for the remaining 50% of the entirety of the molecule, and a composition (3) constituted by 3.5 g of the block copolymer (3) were obtained in a manner similar to that in Example 1, except that the amount of NMP used in the step (a) was changed to 4177 g, the amount of calcium chloride used was changed to 366.29 g, the amount of DDS used in the step (c) was changed to 140.853 g, the total amount of TPC used in each of the steps (d) and (f) was changed to 227.615 g, the amount of PPD used in the step (f) was changed to 61.344 g, the temperature of the solution A(3) in the step (d) was changed to 20° C., the temperature of the solution B(3) in the step (g) was changed to 20° C., and the water content in the step (b) was adjusted to 400 ppm. Note that, in Example 3, the weight of the block A(3) relative to the weight of the reaction solution A(3) was 4.48% by weight.

A contained amount of a component that is contained in the composition and that is to be eluted into NMP was measured in a manner similar to that in Example 1, except that the composition (3) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in Example 1, except that a solution containing the block copolymer (3) was used instead of the solution containing the block copolymer (1), and that the amount of NMP used was changed to 6.83 L and the amount of aluminum oxide used was changed to 280.0 g.

### EXAMPLE 4

A reaction solution A(4), a solution containing a block copolymer (4) in which the block A(4) accounted for 50% of the entirety of a molecule and the block B(4) accounted for the remaining 50% of the entirety of the molecule, and a composition (4) constituted by 3.5 g of the block copolymer (4) were obtained in a manner similar to that in Example 1, except that the amount of NMP used in the step (a) was changed to 4177 g, the amount of calcium chloride used was changed to 366.29 g, the amount of DDS used in the step (c) was changed to 141.119 g, the total amount of TPC used in each of the steps (d) and (f) was changed to 226.911 g, the amount of PPD used in the step (f) was changed to 61.460 g, the temperature of the solution A(4) in the step (d) was changed to 20° C., the temperature of the solution B(4) in the step (g) was changed to 20° C., and the water content in the step (b) was adjusted to 300 ppm. Note that, in Example 4, the weight of the block A(4) relative to the weight of the reaction solution A(4) was 4.48% by weight.

A contained amount of a component that is contained in the composition and that is to be eluted into NMP was measured in a manner similar to that in Example 1, except that the composition (4) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in Example 1, except that a solution containing the block copolymer (4) was used instead of the solution containing the block copolymer (1), and that the amount of NMP used was changed to 6.83 L and the amount of aluminum oxide used was changed to 280.0 g.

### EXAMPLE 5

eaction solution A(5), a solution containing a block copolymer (5) in which the block A(5) accounted for 50% of the entirety of a molecule and the block B(5) accounted for the remaining 50% of the entirety of the molecule, and a composition (5) constituted by 3.5 g of the block copolymer (5) were obtained in a manner similar to that in Example 1, except that the amount of NMP used in the step (a) was changed to 4177 g, the amount of calcium chloride used was changed to 366.29 g, the amount of DDS used in the step (c) was changed to 141.119 g, the total amount of TPC used in each of the steps (d) and (f) was changed to 226.911 g, the amount of PPD used in the step (f) was changed to 61.460 g, the temperature of the solution A(5) in the step (d) was changed to 20° C., the temperature of the solution B(5) in the step (g) was changed to 20° C., and the water content in the step (b) was adjusted to 730 ppm. Note that, in Example 5, the weight of the block A(5) relative to the weight of the reaction solution A(5) was 4.48% by weight.

A contained amount of a component that is contained in the composition and that is to be eluted into NMP was measured in a manner similar to that in Example 1, except that the composition (5) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in Example 1, except that a solution containing the block copolymer (5) was used instead of the solution containing the block copolymer (1), and that the amount of NMP used was changed to 6.83 L and the amount of aluminum oxide used was changed to 280.0 g.

### EXAMPLE 6

A reaction solution A(6), a solution containing a block copolymer (6) in which the block A(6) accounted for 50% of the entirety of a molecule and the block B(6) accounted for the remaining 50% of the entirety of the molecule, and a composition (6) constituted by 3.5 g of the block copolymer (6) were obtained in a manner similar to that in Example 1, except that the amount of NMP used in the step (a) was changed to 4177 g, the amount of calcium chloride used was changed to 366.29 g, the amount of DDS used in the step (c) was changed to 141.119 g, the total amount of TPC used in each of the steps (d) and (f) was changed to 226.911 g, the amount of PPD used in the step (f) was changed to 61.460 g, the temperature of the solution A(6) in the step (d) was changed to 20° C., the temperature of the solution B(6) in the step (g) was changed to 20° C., and the water content in the step (b) was adjusted to 1000 ppm. Note that, in Example 6, the weight of the block A(6) relative to the weight of the reaction solution A(6) was 4.48% by weight.

A contained amount of a component that is contained in the composition and that is to be eluted into NMP was measured in a manner similar to that in Example 1, except that the composition (6) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in Example 1, except that a solution containing the block copolymer (6) was used instead of the solution containing the block copolymer (1), and that the amount of NMP used was changed to 6.83 L and the amount of aluminum oxide used was changed to 280.0 g.

### EXAMPLE 7

A reaction solution A(7), a solution containing a block copolymer (7) in which the block A(7) accounted for 20% of the entirety of a molecule and the block B(7) accounted for the remaining 80% of the entirety of the molecule, and a composition (7) constituted by 3.0 g of the block copolymer (7) were obtained in a manner similar to that in Example 1, except that the amount of NMP used in the step (a) was changed to 4177 g, the amount of calcium chloride used was changed to 366.29 g, the amount of DDS used in the step (c) was changed to 79.159 g, the total amount of TPC used in each of the steps (d) and (f) was changed to 210.978 g, the amount of PPD used in the step (f) was changed to 80.443 g, the temperature of the solution A(7) in the step (d) was changed to 20° C., the temperature of the solution B(7) in the step (g) was changed to 20° C., and the water content in the step (b) was adjusted to 300 ppm. Note that, in Example 7, the weight of the block A(7) relative to the weight of the reaction solution A(7) was 2.55% by weight.

A contained amount of a component that is contained in the composition and that is to be eluted into NMP was measured in a manner similar to that in Example 1, except that the composition (7) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in Example 1, except that a solution containing the block copolymer (7) was used instead of the solution containing the block copolymer (1), and that the amount of NMP used was changed to 6.33 L and the amount of aluminum oxide used was changed to 240.0 g.

### COMPARATIVE EXAMPLE 1

<Preparation of Composition>

A solution containing a comparative polymer (1) was obtained by a method which included the following steps (a′) through (e′).

(a′) A 5-L separable flask having a stirring blade, a thermometer, a nitrogen incurrent canal, and a powder addition port was sufficiently dried.

(b′) 4280 g of NMP was introduced into the flask. Further, 329.08 g of calcium chloride (which had been dried at 200° C. for 2 hours) was added, and a resulting mixture was heated to 100° C. The calcium chloride was completely dissolved to obtain a solution of calcium chloride. Here, in the solution of calcium chloride, a concentration of calcium chloride was 7.14% by weight, and a water content was adjusted to be 500 ppm.

(c′) To the solution of calcium chloride, 138.932 g of PPD was added while the temperature was maintained at 30±2° C., and the PPD was completely dissolved to obtain a comparative solution A.

(d′) The resulting comparative solution A was cooled to 20° C. After that, to the comparative solution A which had been cooled, a total of 251.499 g of terephthalic acid dichloride (TPC) was added in three separate portions while the temperature was maintained at 20±2° C. A reaction was then caused to occur for 1 hour, and a comparative reaction solution A was obtained.

(e′) While the temperature of the comparative reaction solution A was maintained at 20±2° C., the solution was matured for 1 hour. After that, the solution was stirred for 1 hour under reduced pressure, and air bubbles were removed. As a result, a solution containing a comparative polymer (1) constituted by poly(paraphenylene terephthalamide) was obtained. The comparative polymer (1) is a resin having an amide bond.

In a flask, 0.5 L of ion-exchange water was introduced. Further, 50 mL of the solution containing the comparative polymer (1) was weighed and collected. After that, 50 mL of the collected solution containing the comparative polymer (1) was added to the flask, and the comparative polymer (1) was deposited. The deposited comparative polymer (1) was separated by a filtration operation to obtain a comparative composition (1) which was constituted by 3.0 g of the comparative polymer (1). Note that, in the filtration operation, the solution remained after the deposition of the comparative polymer (1) was filtered once, and then 100 mL of ion-exchange water was added to the resulting deposit containing the cyclic component and filtration was carried out again. That is, filtration was carried out twice.

A contained amount of a component that is contained in the composition and that is to be eluted into NMP was measured in a manner similar to that in Example 1, except that the comparative composition (1) was used instead of the composition (1). A porous layer and a laminated separator were prepared, physical property values of the porous layer and the laminated separator were measured, a short circuit time was measured, and a contained amount of a component that is contained in the porous layer and that is to be eluted into NMP were measured in a manner similar to that in

Example 1, except that a solution containing the comparative polymer (1) was used instead of the solution containing the block copolymer (1), and that the amount of NMP used was changed to 6.33 L and the amount of aluminum oxide used was changed to 240.0 g.

Table 1 below shows the contained amount of the component that is contained in the composition and that is to be eluted into NMP, the physical property values of the porous layer and the laminated separator, and the short circuit time which were measured in each of Examples 1 through 7 and Comparative Example 1.

TABLE 1

| | | | | Laminated | Composition | Nonaqueous |
|---|---|---|---|---|---|---|
| | Porous layer | | | separator | Contained amount of | electrolyte |
| | | Weight per | Air | Weight per | component that is to | secondary battery |
| | Thickness | unit area | permeability | unit area | be eluted into NMP | Short circuit time |
| | [μm] | [g/m²] | [s/100 cc] | [g/m²] | [% by weight] | [number of cycles] |
| Example 1 | 12.9 | 1.8 | 288 | 7.88 | 18.7 | 201 |
| Example 2 | 12.6 | 1.7 | 274 | 7.75 | 18.8 | 173 |
| Example 3 | 12.5 | 1.7 | 268 | 7.84 | 11.7 | 189 |
| Example 4 | 12.6 | 1.7 | 268 | 7.71 | 9.5 | 199 |
| Example 5 | 13.9 | 1.9 | 215 | 7.98 | 18.9 | 200 |
| Example 6 | 13.9 | 1.9 | 218 | 7.99 | 21.7 | 207 |
| Example 7 | 12.5 | 1.7 | 294 | 7.74 | 7.3 | 175 |
| Comparative | 13.0 | 1.7 | 302 | 7.79 | 0.2 | 157 |
| Example 1 | | | | | | |

[Conclusion]

In Examples 1 through 7 and Comparative Example 1, as a result of measuring the contained amount of the component that is contained in the porous layer and that is to be eluted into NMP, the contained amount of the component that is contained in the porous layer and that is to be eluted into NMP was not substantially changed from the contained amount of the component that is contained in the composition and that is to be eluted into NMP. Therefore, it has been found that the porous layer in accordance with an embodiment of the present invention can be produced by using, as a raw material, a composition which is constituted by a resin having an amide bond and in which a contained amount of a component that is to be eluted into NMP is not less than 6.0% by weight and not more than 25.0% by weight.

As shown in Table 1, the short circuit time of the nonaqueous electrolyte secondary battery including any of the porous layers described in Examples 1 through 7 is greater than the short circuit time of the nonaqueous electrolyte secondary battery including the porous layer described in Comparative Example 1. Therefore, it has been found that the porous layer in accordance with an embodiment of the present invention can improve durability of a nonaqueous electrolyte secondary battery with respect to charge-discharge cycles.

### INDUSTRIAL APPLICABILITY

The nonaqueous electrolyte secondary battery porous layer in accordance with an embodiment of the present invention can be suitably utilized as a member of a nonaqueous electrolyte secondary battery which is excellent in durability with respect to charge-discharge cycles.

1. A nonaqueous electrolyte secondary battery porous layer comprising at least one type of a resin having an amide bond,
the resin having the amide bond containing a component that is to be eluted into N-methylpyrrolidone, and
a contained amount of the component that is to be eluted into N-methylpyrrolidone being not less than 6.0% by weight and not more than 25.0% by weight relative to a total weight of the resin having the amide bond,
where the contained amount of the component that is to be eluted into N-methylpyrrolidone is measured by carrying out extraction with respect to the nonaqueous electrolyte secondary battery porous layer using N-methylpyrrolidone.

2. The nonaqueous electrolyte secondary battery porous layer as set forth in claim 1, wherein:
at least one type of the resin having the amide bond is a block copolymer including a block A containing, as a main component, units each represented by Formula (1) below, and a block B containing, as a main component, units each represented by Formula (2) below.
—(NH—Ar¹—NHCO—Ar²—CO—)— Formula (1)
—(NH—Ar³—NHCO—Ar⁴—CO)— Formula (2)
where:
Ar¹, Ar², Ar³, and Ar⁴ may each vary from unit to unit; Ar¹, Ar², Ar³, and Ar⁴ are each independently a divalent group having one or more aromatic rings;
not less than 50% of all Ar¹ each have a structure in which two aromatic rings are connected by a sulfonyl bond;
not more than 50% of all Ar³ each have a structure in which two aromatic rings are connected by a sulfonyl bond; and
10% to 70% of all Ar¹ and Ar³ each have a structure in which two aromatic rings are connected by a sulfonyl bond.

3. The nonaqueous electrolyte secondary battery porous layer as set forth in claim 1, further comprising a filler,
a contained amount of the filler being not less than 20% by weight and not more than 90% by weight relative to a total weight of the nonaqueous electrolyte secondary battery porous layer.

4. A nonaqueous electrolyte secondary battery laminated separator, wherein a nonaqueous electrolyte secondary battery porous layer recited in claim 1 is formed on one surface or both surfaces of a polyolefin porous film.

5. A nonaqueous electrolyte secondary battery member, comprising a positive electrode, a nonaqueous electrolyte secondary battery porous layer recited in claim 1, and a negative electrode which are disposed in this order.

6. A nonaqueous electrolyte secondary battery comprising a nonaqueous electrolyte secondary battery porous layer recited in claim 1.

7. A nonaqueous electrolyte secondary battery member, comprising a positive electrode, a nonaqueous electrolyte secondary battery laminated separator recited in claim 4, and a negative electrode which are disposed in this order.

8. A nonaqueous electrolyte secondary battery comprising a nonaqueous electrolyte secondary battery laminated separator recited in claim 4.
